(19) United States
(12) Patent Application Publication
(10) Pub. No.: US 2006/0051593 A1
(43) Pub. Date: Mar. 9, 2006

(54) Urethane acrylate composite structure

(76) Inventors: Calvin T. Peeler, Canton, MI (US); David D. Peters, Wyandotte, MI (US); David Kielbasa, Oak Park, MI (US); Heinz Plaumann, Flat Rock, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/239,892

(22) Filed: Sep. 30, 2005

Related U.S. Application Data
(63) Continuation-in-part of application No. 10/832,903, filed on Apr. 27, 2004.
(63) Continuation-in-part of application No. 10/935,437, filed on Sep. 7, 2004.
(63) Continuation-in-part of application No. 10/935,549, filed on Sep. 7, 2004.
(63) Continuation-in-part of application No. 10/955,369, filed on Sep. 30, 2004.
(63) Continuation-in-part of application No. 11/088,531, filed on Mar. 24, 2005.
(63) Continuation-in-part of application No. 11/088,425, filed on Mar. 24, 2005.
(63) Continuation-in-part of application No. 11/088,426, filed on Mar. 24, 2005.

(51) Int. Cl. B32B 27/40

(52) U.S. Cl. 428/423.1

(57) ABSTRACT

A urethane acrylate composite structure includes a first layer that is a show surface of the urethane acrylate composite structure and a support layer. The support layer includes a urethane acrylate composition that includes a urethane acrylate adduct. The urethane acrylate adduct is the reaction product of an isocyanate component and a stoichiometric excess of a functionalized acrylate component. The isocyanate component includes toluene diisocyanate and polymeric polyphenylmethane polyisocyanate. The functionalized acrylate component is reactive with the isocyanate component. The urethane acrylate composition exhibits improved viscosity due to the isocyanate component. The combination of the toluene diisocyanate and the polymeric polyphenylmethane polyisocyanate results in the improved viscosity of the urethane acrylate composition while maintaining excellent resin curing and finished composite structure properties.

### RELATED APPLICATIONS

This application is a continuation-in-part of co-pending U.S. patent application Ser. Nos. 10/832,903, 10/935,437, 10/935,549, 10/955,369, 11/088,531, 11/088,425, and 11/088,426, which were filed on Apr. 27, 2004, Sep. 7, 2004, Sep. 7, 2004, Sep. 30, 2004, Mar. 24, 2005, Mar. 24, 2005, and Mar. 24, 2005, respectively.

### FIELD OF THE INVENTION

The present invention generally relates to a urethane acrylate composite structure, a urethane acrylate composition, and a urethane acrylate adduct. More specifically, the urethane acrylate composition and urethane acrylate adduct of the present invention exhibit low viscosity while maintaining excellent resin curing and finished composite structure properties.

### BACKGROUND OF THE INVENTION

Urethane acrylate compositions are known in the art for use in applications such as coatings and composite structures. Urethane acrylate compositions include a urethane acrylate adduct that is the reaction product of an isocyanate component and a functionalized acrylate component that is reactive with the isocyanate component. The urethane acrylate compositions are generally produced by charging a reactor with the functionalized acrylate component and the isocyanate component and reacting those components at elevated temperatures, in excess of 60° C., for a sufficient amount of time to consume, or react, all of the isocyanate groups of the isocyanate component.

Typically, the viscosity of the urethane acrylate compositions of the prior art is high, especially for the urethane acrylate compositions with a high degree of functionality. Further, the degree of functionalization can be related to the excellent resin curing and finished composite structure properties, such as high heat distortion properties. The urethane acrylate compositions having high viscosities, i.e., viscosities above 7500 centipoise at 25° C., are more difficult to handle during the manufacturing processes for the composite structures than urethane acrylate compositions having lower viscosities. Typically, the viscosity of such urethane acrylate compositions is reduced through the addition of either reactive or non-reactive diluents. However, substantial amounts of the diluents are required to sufficiently reduce the viscosity of the urethane acrylate compositions. More specifically, greater than 35 parts by weight of the diluent, based on the total weight of the urethane acrylate composition, is required.

In the art of polyurethane compositions, U.S. Pat. No. 5,312,888 to Nafziger et al. discloses a binder composition including a polyol and an isocyanate component that may include toluene diisocyanate, polymethylene polyphenylpolyisocyanate, or methylene diphenyl-diisocyanate. The '888 patent recognizes that varying the amount of the isocyanate component to the amount of the polyol will affect the viscosity of the resulting polyurethane. The '888 patent does not disclose, teach, or suggest substituting the functionalized acrylate in place of the polyol to result in a urethane acrylate composition and not the polyurethane of the '888 patent. Urethane acrylate compositions have superior properties to the polyurethane composition, such as excellent resistance to deflection and weakening at elevated temperatures without a post-curing process step. Furthermore, urethane acrylate compositions also afford broader process latitude. In urethane acrylate compositions, the isocyanate component and the functionalized acrylate component are reacted with each other in a prior processing step, and the urethane acrylate composition is cured through a radical curing process to form the composite structure. As a result, the urethane acrylate composition is insensitive to moisture and many of the thermal effects which impair the urethane-forming reaction. Further, the '888 patent teaches that the isocyanate component may include only toluene diisocyanate and methylene diphenyl diisocyanate which, if used in the urethane acrylate composition of the subject invention, would crystallize the urethane acrylate composition when a 2:1 equivalent ratio of the functionalized acrylate component to that isocyanate component is used. The crystallize urethane acrylate composition would be useless for applications where spraying of the urethane acrylate composition is required. The '888 patent also fails to recognize any other mechanisms for reducing the viscosity of the resulting polyurethane prepolymer.

In the realm of urethane acrylate compositions, U.S. Pat. No. 6,509,086 discloses a composite structure having a show surface and a support layer. The support layer is formed from a urethane acrylate composition that includes up to 50 parts by weight of a urethane acrylate adduct, based on the total weight of the urethane acrylate composition. The urethane acrylate adduct is the reaction product of isophorone diisocyanate, i.e., the isocyanate component, and a stoichiometric amount of 2-hydroxyethyl methacrylate (HEMA), i.e., the functionalized acrylate component. The '086 patent suggests adding polymethyl methacrylate (PMMA) to the urethane acrylate composition in order to adjust the viscosity and to improve curing. Adding the PMMA increases the cost of the urethane acrylate composition and may also increase VOCs, which is undesirable. Like the '888 patent, the '086 patent fails to recognize any other mechanism for reducing the viscosity of the resulting urethane acrylate composition. Furthermore, the '086 patent does not recognize using a combination of TDI and PMDI for the isocyanate component.

Due to the deficiencies of the prior art, including those described above, there remains an opportunity to further reduce the viscosity of urethane acrylate compositions while maintaining excellent resin curing and finished composite structure properties and to decrease the cost and increase the efficiency of manufacturing processes for making the composite structures.

### SUMMARY OF THE INVENTION AND ADVANTAGES

The subject invention provides a urethane acrylate composite structure, a urethane acrylate composition, and a urethane acrylate adduct. The urethane acrylate adduct is the reaction product of an isocyanate component and a stoichiometric excess of a functionalized acrylate component that is reactive with the isocyanate component. The isocyanate component includes toluene diisocyanate (TDI) and polymeric polyphenylmethane polyisocyanate.

The urethane acrylate composition and the urethane acrylate adduct exhibit low viscosity while maintaining excellent resin curing and finished composite structure properties. More specifically, the combination of the toluene diisocyanate and the polymeric polyphenylmethane polyisocyanate drastically reduces the viscosity of the urethane acrylate composition made therefrom, relative to urethane acrylate compositions that use other isocyanate components or combinations of isocyanate components, so that the urethane acrylate composition can be processed easier when making urethane acrylate composite structures. Furthermore, the finished composite structures have excellent resistance to deflection and weakening at elevated temperatures after curing.

### DETAILED DESCRIPTION OF A PREFERRED EMBODIMENT

A urethane acrylate composite structure according to the subject invention may be used in the composite industry, including, but not limited to, transportation, bathware, and marine applications. The urethane acrylate composite structure includes a first layer and a support layer. Ultimately, the first layer is a show surface of the urethane acrylate composite structure. The support layer includes a urethane acrylate composition including a urethane acrylate adduct. The urethane acrylate adduct is the reaction product of an isocyanate component and a functionalized acrylate component that is reactive with the isocyanate component, to be described in further detail below. The support layer provides structural integrity and durability to the complete urethane acrylate composite structure. As such, the support layer is preferably at least 0.125 inches thick, but may be varied based on the physical and performance requirements of the completed urethane acrylate composite structure. The composite structure may be constructed from several individual layers of the urethane acrylate composition that are used to encapsulate other structural elements such as, but not limited to, wood, cardboard, or metal reinforcing materials. In one embodiment, the urethane acrylate composite structure further includes a second layer. Preferably, the second layer is formed from a second urethane acrylate composition including a second urethane acrylate adduct. The second urethane acrylate composition and second urethane acrylate adduct may be the same as the urethane acrylate composition of the support layer. However, it is to be appreciated that the second layer may be formed from other compositions, such as, but not limited to, those including polyurethanes, styrenated polyesters, or vinyl ester-based compositions. When present, the second layer is disposed between the first layer and the support layer and preferably has a smooth texture to maintain an acceptable appearance of the first layer.

Preferably, the first layer and the support layer are formed on a mold substrate in an open-mold process to form the urethane acrylate composite structure. However, it is to be appreciated that the first layer and support layer may be formed in a closed mold to form the urethane acrylate composite structure. Preferably, a surface of the mold substrate is coated with a known mold release agent to facilitate the eventual removing of the urethane acrylate composite structure. By way of non-limiting example, the mold release agent may be a composition including silicones, soaps, waxes and/or solvents. For the open-mold process, the first layer is formed over the mold release agent on the surface of the mold substrate. Typically, the first layer is cured at a temperature of about 20° C. to about 35° C. for a length of time sufficient to prevent bleeding through and read through, but not so long as to prevent bonding of the support layer or other subsequent layers. Typically, the first layer is cured for about one hour. The urethane acrylate composition is then applied to the first layer to form the support layer. The urethane acrylate composition has sufficiently low viscosity, to be described in further detail below, to enable processing of the urethane acrylate composition through various processing methods while maintaining excellent resin curing and finished composite structure properties. One example of a processing method involves spray application of the urethane acrylate composition during production of the urethane acrylate composite structure. It is to be appreciated that the urethane acrylate composition may also be poured or injected; however, spraying is preferred for certain urethane acrylate composite structures. In another embodiment, the urethane acrylate composition is applied to the mold to form the support layer and removed prior to forming the first layer. The first layer is then formed on the support layer outside of the mold in a post-production paint operation.

In another embodiment, the urethane acrylate composite structure may be produced by first forming the first layer in the mold, forming the second layer, or barrier coat, on the first layer, and forming the support layer on the second layer. The complete urethane acrylate composite structure is then removed from the mold. Alternatively, the urethane acrylate composite structure may be produced by forming the second layer in the mold, forming the support layer on the second layer, removing the second and support layers from the mold, and then forming the first layer on the second layer outside of the mold to produce the complete urethane acrylate composite structure. It is to be appreciated that the second layer can be formed from either the same urethane acrylate composition as the support layer, another urethane acrylate composition different from that of the support layer, or other compositions as discussed above such as polyurethanes, styrenated polyesters, or vinyl ester-based compositions.

Preferably, fiber is included in the support layer to reinforce the urethane acrylate composite structure, to eliminate fault propagation, and to provide support for the urethane acrylate composite structure. If included, the fiber includes, but is not limited to, chopped fiberglass, chopped carbon fibers, chopped wood fibers, chopped aramid fibers including all aromatic polyamide materials, chopped polymer fibers such as nylon, and combinations thereof. Preferably, the support layer with the fiber is rolled to eliminate entrained and otherwise trapped air to maximize the density of the support layer and also to smooth the fiber for appearance purposes. However, it is to be appreciated that the rolling process may be eliminated if the physical properties of the composite article, prior to compression, are sufficient for the needs of the specific application. In another embodiment, the urethane acrylate composition without fiber is applied in a thin layer to the first layer to partially form the support layer. Fiber, either chopped or as a mat, is then applied onto the partially-formed support layer to complete the support layer. Optionally, more of the urethane acrylate composition may be applied to the fiber to complete the support layer. The support layer with the fiber is then rolled. Additional fiber-reinforced layers may be formed over other structural materials to encapsulate the other structural materials within the completed composite article. It is to be appreciated that the urethane acrylate composite structure may be produced without the fiber given that the non-reinforced composite structure may yield the desired physical and functional properties. The completed urethane acrylate composite structure is then removed from the mold substrate. After the first layer and the support layer are formed, and also after removing the completed urethane acrylate composite structure, the first layer is a show surface of the urethane acrylate composite structure whereas the support layer is a backing layer to the first layer.

In one embodiment, the first layer includes a styrenated unsaturated polyester gel coat. An example of a typical styrenated unsaturated polyester gel coat is Vipel™ F737-FB Series Polyester Resin (formerly E737-FBL), which is commercially available from AOC Resins of Collierville, Tenn.

In another embodiment, the first layer includes the second urethane acrylate composition including the second urethane acrylate adduct that is the reaction product of a second isocyanate component and a second acrylate component. Preferably, as stated above, the second urethane acrylate composition is the same as the urethane acrylate composition of the support layer. However, it is to be appreciated that the second isocyanate component may be different from the isocyanate component of the support layer. Regardless, the second acrylate component may be any acrylate component suitable for the support layer.

Depending on the intended use of the urethane acrylate composite structure, the second isocyanate component of the subject invention may include an aliphatic isocyanate. For example, for urethane acrylate composite structures that are exposed to direct sunlight, UV stability is critical, especially when UV transparent additives, such as TiO₂ pigment, are utilized. Urethane acrylate adducts that are the reaction product of the aliphatic isocyanate and the second acrylate component are more stable to UV light than urethane acrylate adducts that are the reaction product of an aromatic isocyanate. In other words, for the urethane acrylate composite structures that are exposed to direct sunlight or other source of UV light, the second isocyanate component may also include aromatic isocyanates so long as at least one UV performance-enhancing additive is included such that the first layer is stable under exposure to UV light. For urethane acrylate composite structures where UV stability is not critical, aliphatic isocyanates are not required. Suitable isocyanates for the second isocyanate component, both aromatic and aliphatic, are described below in significant detail. Whenever the term aliphatic is used throughout the subject application, it is intended to indicate any combination of aliphatic, acyclic, and cyclic arrangements. That is, aliphatic indicates both straight chains and branched arrangements of carbon atoms (non-cyclic) as well as arrangements of carbon atoms in closed ring structures (cyclic) so long as these arrangements are not aromatic.

Suitable aliphatic isocyanates for the second isocyanate component include, but are not limited to, hexamethylene diisocyanate (HDI), isophorone diisocyanate (IPDI), dicyclohexane-4,4′ diisocyanate (Desmodur W), hexamethylene diisocyanate trimer (HDI Trimer), isophorone dilsocyanate trimer (IPDI Trimer), hexamethylene diisocyanate biuret (HDI Biuret), cyclohexane diisocyanate, meta-tetramethylxylene diisocyanate (TMXDI), and mixtures thereof. Additionally, it is to be understood that the second isocyanate component may be a pre-polymer. That is, the second isocyanate component may include any of the aforementioned isocyanates and a stoichiometrically insufficient amount of the second acrylate component. Further, the acrylate component of these pre-polymers could contain multiple isocyanate reactive groups or a single isocyanate reactive group and multiple reactive acrylate or olefinic functionalities. The second isocyanate component may also include an aromatic isocyanate. In such cases, as discussed above, it may be necessary to include at least one UV performance-enhancing additive such that the second urethane acrylate composition is stable under exposure to UV light.

In another embodiment, the first layer is formed from a paint for enhancing the appearance of the urethane acrylate composite structure. It is to be appreciated that the paint may include any pigment or organic dye known in the art, such as the TiO₂ as set forth above, or any other paint or gel coat as known in the art for including in the first layer that is the show surface. Other examples of paint suitable for the subject invention include paint selected from the group of latex-based water-borne, latex-based solvent-borne, acrylic-based water-born, acrylic-based solvent-borne paints, and styrenated polyester gel coats.

As stated above, the support layer includes the urethane acrylate composition, which includes the urethane acrylate adduct and, optionally, other additives and fillers as may be necessary to achieve desired physical properties. The urethane acrylate adduct is the reaction product of the isocyanate component and the functionalized acrylate component that is reactive with the isocyanate component. More specifically, the isocyanate component includes toluene diisocyanate (TDI) and polymeric polyphenylmethane polyisocyanate (PMDI). In one embodiment, the isocyanate component also includes monomeric diphenylmethane diisocyanate (MMDI). Blending the TDI and PMDI drastically reduces the viscosity of the urethane acrylate composition, thus improving the processability of the urethane acrylate composition, as compared to urethane acrylate compositions that use other individual isocyanate components without compromising the physical properties of the urethane acrylate composition after curing. Furthermore, blending the TDI and the PMDI reduces the tendency of the urethane acrylate composition to crystallize. However, isocyanate components that include MMDI, in addition to the TDI and the PMDI, yield the most significant viscosity reduction while maintaining the reduced tendency to crystallize. The viscosity of the urethane acrylate composition, as well as physical properties of the urethane acrylate composition after curing, will be described in further detail below.

Preferred TDI suitable for the subject invention includes 2,4- and 2,6-toluene diisocyanate and the corresponding isomeric mixtures. A specific example of TDI suitable for the subject invention is Lupranate® T-80, which is an 80%-20% mixture of 2,4- and 2,6-toluene diisocyanate and is commercially available from BASF Corporation of Wyandotte, Mich. However, it is to be appreciated that any combination of 2,4- and 2,6-toluene diisocyanate, as well as either 2,4- or 2,6-toluene diisocyanate alone, may be suitable for the subject invention. It is also to be appreciated that the TDI may be present in the isocyanate component as an isocyanate pre-polymer of TDI and a suitable functionalized acrylate, specific examples of which are described in further detail below.

Preferred PMDI, which is also known as polymethylene polyphenylpolyisocyanate or polymeric MDI, includes any PMDI having an average isocyanate functionality of greater than 2.0. A specific example of a suitable PMDI is Lupranate® M20S, which is also commercially available from BASF Corporation and has an isocyanate functionality of about 2.7. It is also to be appreciated that the PMDI may be present in the isocyanate component as an isocyanate pre-polymer of PMDI and a suitable functionalized acrylate, specific examples of which are described in further detail below.

Preferably, the TDI is present in the isocyanate component in an amount of at least 25 parts by weight based on the total weight of the isocyanate component in order to both sufficiently depress a freezing point of the isocyanate component at room temperature and to sufficiently lower the viscosity of the isocyanate component, as shown in the Examples section below., In a more preferred embodiment, the TDI is present in the isocyanate component in an amount of from 25 to 80 parts by weight, and most preferably from 30 to 60 parts by weight, based on the total weight of the isocyanate component. Preferably, the PMDI is present in the isocyanate component in an amount of at least 10 parts by weight, more preferably from 25 to 65 parts by weight, and most preferably from 30 to 60 parts by weight, based on the total weight of the isocyanate component, in order to achieve the desired viscosity of the urethane acrylate composition and the reduced any tendency of the isocyanate component to crystallize at room temperature for a period of at least 90 days.

As set forth above, the isocyanate component may optionally include, in addition to the TDI and the PMDI, monomeric diphenylmethane diisocyanate (MMDI). The resulting isocyanate component may be characterized as a trinary blend of isocyanates. Preferably, when used, the MMDI is present in an amount of at least 25 parts by weight, more preferably from 25 to 44 parts by weight, most preferably from 36 to 38 parts by weight, based on the total weight of the isocyanate component.

It is to be appreciated that other isocyanates such as conventional aliphatic, cycloaliphatic, araliphatic, and other aromatic isocyanates may also be included in the isocyanate component without adversely affecting the viscosity of the urethane acrylate composition. Specific examples of the other isocyanates include, but are not limited to, alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures, aromatic diisocyanates such as 4,4′-, 2,4′-, and 2,2′-diphenylmethane diisocyanate and the corresponding isomeric mixtures, as well as mixtures of any of the aforementioned isocyanate components.

The functionalized acrylate component, as set forth above for the urethane acrylate adduct and the second urethane acrylate adduct, has at least one isocyanate-reactive group selected from the group of hydroxy-functional groups, amine-functional groups, and combinations thereof. Preferably, the functionalized acrylate component has from one to four of the isocyanate-reactive groups. In a most preferred embodiment, the functionalized acrylate component has one isocyanate-reactive group for providing sufficiently low viscosity, to be discussed in further detail below, to enable processing of the urethane acrylate composition during the production of the urethane acrylate composite structure.

Suitable hydroxy-functional groups include hydroxy-functional alkyl groups having from two to twenty carbon atoms. Specific examples of functionalized acrylate components including suitable hydroxy-functional groups include, but not limited to, hydroxyethyl, hydroxypropyl, and hydroxybutyl acrylates and alkacrylates, and combinations thereof. It is to be appreciated that the functionalized acrylates may include more than one of the aforementioned hydroxy-functional groups and may be incorporated as a pre-polymer as described above.

Preferably, the functionalized acrylate component includes at least one alkyl chain, separate from the hydroxy-functional alkyl groups, having from one to twenty carbon atoms. Specific examples of functionalized acrylate components including suitable alkyl chains include, but are not limited to, methacrylates, ethacrylates, propacrylates, butacrylates, phenylacrylates, methacrylamides, ethacrylamides, butacrylamides, and combinations thereof. Preferred functionalized acrylate components include hydroxyethyl methacrylate, hydroxypropyl methacrylate, hydroxymethyl ethacrylate, hydroxyethyl ethacrylate, hydroxypropyl ethacrylate, glycerol dimethacrylate, N-methylol methacrylamide, 2-tert-butyl aminoethyl methacrylate, dimethylaminopropyl methacrylamide, and combinations thereof. In a most preferred embodiment, the functionalized acrylate component is a hydroxyethyl methacrylate. It is to be appreciated that functionalized alkylacrylates and functionalized acrylates may be used interchangeably, i.e., hydroxyethyl acrylate may be used in place of hydroxyethyl methacrylate and vice versa.

Many urethane acrylate adducts have a high viscosity, making them difficult to process through various production methods, as discussed below. As discussed above, it has been found that the viscosity of the urethane acrylate adduct, and thus, the urethane acrylate composition, may be decreased by using the specific mixtures of either TDI and PMDI or TDI, MMDI, and PMDI, preferably within the amount ranges as set forth above. In addition, the viscosity of the urethane acrylate adduct may also be adjusted by selecting the functionalized acrylate component according to the number of functional groups per functionalized acrylate component and by varying the amount of the functionalized acrylate component relative to the isocyanate component.

The functionalized acrylate component is provided in a stoichiometric excess with respect to the isocyanate component. The excess acrylate component functions as a reactive diluent for lowering the viscosity of the urethane acrylate adduct. Preferably, the stoichiometric excess of the functionalized acrylate component is defined as a range of molar equivalent ratios, i.e., a ratio of isocyanate-reactive groups to isocyanate groups, of the functionalized acrylate component to the isocyanate component of at least 1.1:1, more preferably at least 1.5:1, and most preferably about 2:1. The actual amounts by weight of the functionalized acrylate component and the isocyanate component will vary depending on the specific functionalized acrylate or mixture of functionalized acrylates used and the specific isocyanate composition used in the isocyanate component.

Optionally, the urethane acrylate composition further includes a reactive diluent other than the excess functionalized acrylate component primarily to further lower the viscosity of the urethane acrylate composition. The reactive diluent has at least one acrylate-reactive functional group selected from the group of vinyl, allyl, cyclic allyl, cyclic vinyl, acrylic, functionalized acrylic, acrylamides, acrylonitrile, and combinations thereof for reacting with acrylate groups of the functionalized acrylate component that remain unreacted after the isocyanate component and the functionalized acrylate component react. Specific examples of reactive diluents that are suitable for the subject invention include, but are not limited to, styrene, divinyl benzene, allyl alkylacrylates, vinyl toluene, diacetone acrylamide, acrylonitrile, methyl methacrylate, hydroxyethyl methacrylate, hydroxypropyl methacrylate, alpha methyl styrene, butyl styrene, monochlorostyrene, and combinations thereof.

Preferably, the weight ratio of the reactive diluent to the functionalized acrylate component is at least 0.01:1. More preferably, the weight ratio of the reactive diluent to the functionalized acrylate component is from 0.1:1 to 1:1. In terms of actual amounts by weight, the reactive diluent is preferably present in an amount of less than or equal to 50 parts by weight, more preferably from 5 to 25 parts by weight, and most preferably from 7 to 15 parts by weight, based on the total weight of the urethane acrylate composition. Alternatively, a non-reactive diluent, as is known in the art, may be used. When used, the non-reactive diluent is preferably added in an amount of from 5 to 10 parts by weight based on the total weight of the urethane acrylate composition.

Preferably, the urethane acrylate composition further includes an inhibitor. Preferably, the inhibitor includes a functional group that is sterically hindered. Steric hindrance ensures that the functional group of the inhibitor remains unreacted during the reaction between the isocyanate component and the functionalized acrylate component. The inhibitor is present to aid in the prevention of unwanted side reactions during the reaction between the isocyanate component and the functionalized acrylate component and to preserve the final urethane acrylate composition. Due to the steric hindrance of the functional group of the inhibitor, the inhibitor is slow to react with the isocyanate component. As such, the functional group of the inhibitor remains unreacted during the reaction between the isocyanate component and the functionalized acrylate component, especially at reaction temperatures of less than 60° C. The preferred inhibitors are described in further detail below. By remaining unreacted during the reaction between the isocyanate component and the functionalized acrylate component, the inhibitor is not consumed and is present in the final urethane acrylate composition to stabilize the urethane acrylate composition.

The inhibitor preferably includes a hindered phenol, a hindered amine, or a combination of the hindered phenol and hindered amine. As is known in the art, inhibitors can be used to help control the rate of the radical curing/polymerization reaction. The hindered phenols promote slower gelling of the urethane acrylate compositions as compared to the hindered amines and are thus more preferred for the manufacturing processes that require slower gel times. Conversely, hindered amines tend to promote and accelerate the curing of the urethane acrylate composition.

The hindered amines and hindered phenols are slower to react or are non-reactive with the isocyanate component relative to unhindered inhibitors, such as hydroquinone. The rate of reaction can be attributed, in part, to the combination of the steric hindrance about the functional group and acidity of the functional group. Preferably, the hindered phenols suitable for the subject invention include a compound having the formula: 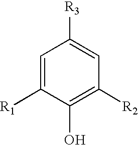
wherein R₁ and R₂ are each selected from the group of aliphatic groups having from one to twenty carbon atoms, aromatic groups having from six to twenty carbon atoms, and combinations thereof, and R₃ is selected from the group of hydrogen, hydroxyl groups, alkyl groups, aryl groups, alkaryl groups, amine groups, and combinations thereof The amine group may be either primary, secondary, or tertiary. The hindered phenols are commonly referred to as such due to the presence of the R₁ and R₂ groups. Preferably, the hindered amines suitable for the subject invention include a compound having the formula: 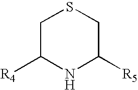
wherein R₄ and R₅ are the same as R₁ and R₂ as set forth above. The hindered phenol and hindered amine are less reactive with the isocyanate groups of the isocyanate component than unhindered phenols, such as p-methoxy hydroquinone (MEHQ), and unhindered amines. Reactivity of the hindered phenols and hindered amines may be reduced by maintaining the reaction temperature lower than 60° C.

The inhibitor may be combined with the functionalized acrylate component prior to the reaction between the functionalized acrylate component and the isocyanate component such that the inhibitor is present during the reaction without reacting with the isocyanate component or otherwise interfering with the production of the urethane acrylate composition. As a result, the inhibitor imparts excellent storage stability in the final urethane acrylate composition.

Specific examples of inhibitors that are suitable for the subject invention include, but are not limited to, a 3,5-bis-(1,1-dimethyl-ethyl)-4-hydroxy benzennepropanic ester of a C₁₄-C₁₅ alcohol blend, butylated hydroxytoluene, triethylene glycol-bis-3,3-t-butyl-4 hydroxy-5 methyl phenyl propionate, pentaerythritol tetrakis [3-(3,5-di-tert-butyl-4-hydroxphenyl)propionate], octadecyl-3,5-di-(tert)-butyl-4-hydroxyhydrocinnamate, a 3,5-bis(1,1-dimethyl-ethyl)-4-hydroxy-C₇-C₉ branched alkylester, 2,2′-methylene-bis(6-t-butyl-4-methylphenol), 2,6-di-tertiary-butyl-4-nonylphenol, a butylated reaction product of p-cresol and dicyclopentadiene, tocopherol, phenothiazine, 2,2,4-trimethyl-1,2-dihydroquinolin, Naugard 445, Naugard PS 30, Irganox 5057, Irganox 565, Naugard 445, and combinations thereof.

When used, the inhibitor is preferably present in the urethane acrylate composition in an amount of from 0.02 to 0.10 parts by weight based on the total weight of the urethane acrylate composition. More preferably, the inhibitor is present in an amount of from 0.02 to 0.05 parts by weight, most preferably from 0.025 to 0.035 parts by weight, based on the total weight of the urethane acrylate composition.

Preferably, the urethane acrylate composition further includes a catalyst. In one embodiment, the catalyst is a temperature-activated catalyst, a specific example of which is cumene peroxide. Alternatively, the catalyst may be selected from the group of photo-initiated, peroxide-based, and hydroperoxide-based catalysts. Specific examples of such catalysts include, but are not limited to, benzoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumene hydroperoxide, paramenthane hydroperoxide, diacetyl peroxide, di-alpha-cumyl peroxide, dipropyl peroxide, diisopropyl peroxide, isopropyl-t-butyl peroxide, butyl-t-butyl peroxide, difuroyl peroxide, bis (triphenylmethyl) peroxide, bis(p-methoxybenzoyl)peroxide, p-monomethoxybenzoyl peroxide, rubene peroxide, propyl hydroperoxide, isopropyl hydroperoxide, n-butyl hydroperoxide, t-butyl hydroperoxide, cyclohexyl hydroperoxide, trans-decalin hydroperoxide, alpha-methylbenzyl hydroperoxide, alpha-methyl-alpha-ethyl benzyl hydroperoxide, tetralin hydroperoxide, triphenylmethyl hydroperoxide, diphenylmethyl hydroperoxide, and combinations thereof.

When used, the total amount of catalyst present in the urethane acrylate composition is preferably from 0.01 to 4 parts by weight, based on the total weight of the urethane acrylate composition to ensure sufficient cure and cross-linking in the reaction of the urethane acrylate composition. More preferably, the total amount of catalyst present is from 0.04 to 3.5 parts by weight, based on the total weight of the urethane acrylate composition. Most preferably, the total amount of catalyst present is from 1.0 to 2.5 parts by weight based on the total weight of the urethane acrylate composition.

The urethane acrylate composition may also include a standard urethane catalyst that is used to promote the urethane reaction between the isocyanate component and the functionalized acrylate component. Further, the urethane acrylate composition may also include a variety of other reaction promoters utilized during curing of the composite structure. When used, the promoters are preferably present in an amount of from 0.01 to 3 parts by weight based on the total weight of urethane acrylate composition and are used to ensure sufficient curing. Specific examples of suitable promoters include, but not limited to, cobalt salts, such as cobalt octoate, cobalt napthanate; cobalt hydroxide, vanadium salts, iron salts and complexes, like ferrocene; potassium octoate; and combinations of these. The selection and usage levels of each are dependent on the desired curing profile of the reaction system, the application with its physical property and performance requirements, and the process through which the urethane acrylate composition is used. Further, other additives such as, but not limited to, reaction accelerators, reaction retarders and combinations of these may also be employed to obtain the desired reaction and curing profiles. Examples of the accelerators include, but are not limited to, amines such as diethyl aniline, dimethyl aniline, dimethyl-para-toluidine and combinations thereof. Examples of gel retarders include, but are not limited to, copper salts, 2,4-pentanedione, alpha-methyl styrene, elevated concentrations of inhibitors, as defined above, and combinations thereof

The urethane acrylate composition may further comprise an additive or additives. If included, the additive is selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, and combinations thereof. Other suitable additives include, but are not limited to, wetting agents, flow modifiers, leveling agents, hydrolysis-protection agents, fungistatic and bacteriostatic substances, dispersing agents, adhesion promoters, and appearance enhancing agents. Each of these additives serves a specific function, or functions, within the urethane acrylate that are known to those skilled in the art.

As described above, the viscosity of the urethane acrylate adduct, and thus, the urethane acrylate composition, prior to forming the support layer must be sufficiently low to enable processing via processing methods such as, but not limited to, spray, injection, infusion or molding applications of the urethane acrylate composition during the production of the urethane acrylate composite structure. The viscosity of the urethane acrylate composition, absent fillers or fiber, is preferably less than 7500 centipoise at 25° C. based on measurements on a Brookfield® RVT viscometer at 60 rpm using a number three spindle. More preferably, the viscosity of the urethane acrylate composition is less than 1600 centipoise, most preferably less than 850 centipoise, at 25° C. If it is desired to add fillers, such as but not limited to calcium carbonate, or fiber to the urethane acrylate composition, the viscosity of the urethane acrylate composition is preferred to be in the range of 150 to 300 centipoise. Once the filler is added to the urethane acrylate composition the viscosity of the urethane acrylate composition can be adjusted with reactive and non-reactive diluents, and/or by heating the urethane acrylate composition to obtain the required viscosity for processing. However, due to the combination of isocyanates of the subject invention, the amount of reactive diluent and/or applied heat that is needed to achieve the target viscosities is minimized.

As also discussed above, the desired viscosity can be achieved for the urethane acrylate composition without sacrificing physical properties of the urethane acrylate composite structure after the urethane acrylate composition cures. More specifically, the urethane acrylate composition, after curing, exhibits good resistance to deflection and weakening. Typically, heat distortion temperatures of the final composite structure exceed 300° F. In addition, adhesion between the first layer and the support layer remains acceptable after curing.

The following examples, illustrating the urethane acrylate composition of the subject invention having the minimized viscosities, are intended to illustrate and not to limit the invention.

### EXAMPLES 1-7

A urethane acrylate composition of the subject invention is produced in a 5 liter, 4-necked round bottom flask. The flask is inspected, cleaned, and purged with air that is free of moisture. The flask is then charged with the functionalized acrylate component, the inhibitor, and catalyst for the reaction between the isocyanate component and the functionalized acrylate component. Agitation is started using an agitator operating at about 250 rpm. The flask is cooled to a temperature of less than or equal to 20° C. The agitation is continued for about 15 minutes to dissolve and disperse the inhibitor in the functionalized acrylate component while maintaining a temperature of less than or equal to 20° C. in the flask. The isocyanate component is then fed into the flask. The temperature in the flask is maintained at or below a feed temperature while the isocyanate component is fed into the flask. Once all of the isocyanate component is fed into the flask, the reaction temperature is maintained within a reaction temperature range. A sample is taken from the flask at about 120 minutes after feeding of the isocyanate component into the flask is started. The sample is analyzed for remaining unreacted isocyanate groups by IR spectroscopy. If the sample includes unreacted isocyanate groups, the heating is continued with additional samples taken every 30 minutes until the reaction is complete. Once the reaction is complete, a 2-4 ounce sample is then taken from the flask to measure viscosity. The viscosity of the sample is measured, as is known to those skilled in the art, at 25° C. on the Brookfield® viscometer with an appropriate spindle and spindle speed for the viscosity range in question. The components and properties of Examples 1-7 are indicated in Table 1 below, wherein all values are in parts by weight based on the total weight of the final urethane acrylate composition, unless otherwise indicated.

TABLE 1

| Component | Ex. 1 | Ex. 2 | Ex. 3 | Ex. 4 |
|---|---|---|---|---|
| Functionalized Acrylate | 69.60 | 69.06 | 70.62 | 70.00 |
| Component A | | | | |
| Inhibitor | 0.03 | 0.05 | 0.03 | 0.03 |
| Isocyanate Component A | 10.11 | 7.70 | 13.02 | 9.97 |
| Isocyanate Component B | 0.00 | 7.70 | 0.00 | 9.97 |
| Isocyanate Component C | 20.21 | 15.40 | 16.28 | 9.98 |
| Catalyst | 0.05 | 0.09 | 0.05 | 0.05 |
| Total | 100.00 | 100.00 | 100.00 | 100.00 |
| Molar Equivalent Ratio of | 2:1 | 2:1 | 2:1 | 2:1 |
| Functionalized Acrylate | | | | |
| Component To Isocyanate | | | | |
| Component | | | | |
| Viscosity, Cps at 25° C. | 1040 | 1000 | 829 | 749 |

| Component | Ex. 5 | Ex. 6 | Ex. 7 |
|---|---|---|---|
| Functionalized Acrylate | 70.34 | 70.67 | 71.12 |
| Component A | | | |
| Inhibitor | 0.03 | 0.03 | 0.03 |
| Isocyanate Component A | 10.77 | 11.70 | 12.80 |
| Isocyanate Component B | 10.77 | 11.70 | 12.80 |
| Isocyanate Component C | 8.08 | 5.85 | 3.20 |
| Catalyst | 0.05 | 0.05 | 0.05 |
| Total | 100.04 | 100.00 | 100.00 |
| Molar Equivalent Ratio of | 2:1 | 2:1 | 2:1 |
| Functionalized Acrylate | | | |
| Component To Isocyanate | | | |
| Component | | | |
| Viscosity, Cps at 25° C. | 675 | 618 | 547 |

### COMPARATIVE EXAMPLES 1-3

Another urethane acrylate composition is produced according to the method as set forth above for Examples 1-7, the difference being that other combinations of isocyanate components, outside of the purview of the subject invention, were used. The components and properties of the specific examples are indicated in Table 2 below, wherein all values are in parts by weight based on the total weight of the final urethane acrylate composition, unless otherwise indicated.

TABLE 2

| | Comparative | Comparative | Comparative |
|---|---|---|---|
| Component | Example 1 | Example 2 | Example 3 |
| Functionalized Acrylate | 67.50 | 71.64 | 66.57 |
| Component A | | | |
| Inhibitor | 0.03 | 0.03 | 0.03 |
| Isocyanate Component A | 0.00 | 14.14 | 0 |
| Isocyanate Component B | 32.42 | 14.14 | 11.11 |
| Isocyanate Component C | 0.00 | 0.00 | 22.24 |
| Catalyst | 0.05 | 0.05 | 0.05 |
| Total | 100.00 | 100.00 | 100.00 |
| Molar Equivalent Ratio of | 2:1 | 2:1 | 2:1 |
| Functionalized Acrylate | | | |
| Component To Isocyanate | | | |
| Component | | | |
| Viscosity, Cps at 25° C. | Crystallized | Crystallized | Crystallized |

Functionalized Acrylate Component A is a 98% hydroxyethyl methacrylate (HEMA) solution, commercially available from Degussa.

Inhibitor is butylated hydroxytoluene (BHT).

Isocyanate Component A is a toluene diisocyanate (TDI) with a functionality of approximately 2.0 and a NCO content of approximately 48.3 parts by weight based on the total weight, commercially available from BASF Corp.

Isocyanate Component B is monomeric diphenylmethane diisocyanate (MMDI) with a functionality of approximately 2.0 and a NCO content of approximately 33.5 parts by weight, commercially available from BASF Corp.

Isocyanate Component C is a polymeric polyphenylmethane polyisocyanate (PMDI) with an actual functionality of approximately 2.7 and a NCO content of approximately 31.5 parts by weight, commercially available from BASF Corp.

Catalyst is dibutyltin dilaurate commercially available from Air Products and Chemicals, Inc.

As is apparent from the above Examples and Comparative Examples, differences in viscosities between the urethane acrylate compositions of the subject invention, shown in Examples 1-7, and the viscosities of Comparative Examples 1-3, are attributed to the amounts of in the isocyanate component, with greater amounts of TDI resulting in lower viscosity. However, absent PMDI, as shown in Comparative Example 2, the urethane acrylate composition crystallizes, thus rendering the urethane acrylate composition useless for applications where spraying of the urethane acrylate composition is required. Furthermore, the use of PMDI and MMDI in the isocyanate component, in the absence of TDI, results in higher viscosity of the urethane acrylate composition, as shown in Comparative Example 3, than when TDI is used. As such, the urethane acrylate composition wherein TDI is included in the isocyanate component is superior, in terms of viscosity, to urethane acrylate compositions where TDI is absent from the isocyanate component.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A urethane acrylate composite structure comprising:
(A) a first layer that is a show surface of said urethane acrylate composite structure; and
(B) a support layer comprising a urethane acrylate composition comprising a urethane acrylate adduct that is the reaction product of:
(I) an isocyanate component comprising a mixture of toluene diisocyanate and polymeric polyphenylmethane polyisocyanate; and
(II) a stoichiometric excess of a functionalized acrylate component that is reactive with said isocyanate component.

2. A urethane acrylate composite structure as set forth in claim 1 wherein said toluene diisocyanate is present in said isocyanate component in an amount of at least 25 parts by weight based on the total weight of said isocyanate component.

3. A urethane acrylate composite structure as set forth in claim 2 said toluene diisocyanate is present in said isocyanate component in an amount of from 25 to 80 parts by weight based on the total weight of said isocyanate component.

4. A urethane acrylate composite structure as set forth in claim 1 wherein said polymeric polyphenylmethane polyisocyanate is present in said isocyanate component in an amount of at least 10 parts by weight based on the total weight of said isocyanate component

5. A urethane acrylate composite structure as set forth in claim 1 wherein said isocyanate component further comprises monomeric diphenylmethane diisocyanate.

6. A urethane acrylate composite structure as set forth in claim 1 wherein at least one of said toluene diisocyanate and said polymeric polyphenylmethane polyisocyanate are in said isocyanate component as an isocyanate pre-polymer.

7. A urethane acrylate composite structure as set forth in claim 1 wherein a molar equivalent ratio of said functionalized acrylate component to said isocyanate component is at least 1.1:1.

8. A urethane acrylate composite structure as set forth in claim 1 wherein said functionalized acrylate component has at least one isocyanate-reactive group selected from the group of hydroxy-functional groups, amine-functional groups, and combinations thereof.

9. A urethane acrylate composite structure as set forth in claim 1 wherein said urethane acrylate composition further comprises a catalyst.

10. A urethane acrylate composite structure as set forth in claim 1 wherein said urethane acrylate composition further comprises an inhibitor.

11. A urethane acrylate composite structure as set forth in claim 1 wherein said urethane acrylate composition further comprises a reactive diluent.

12. A urethane acrylate composite structure as set forth in claim 1 wherein said support layer comprises a fiber.

13. A urethane acrylate composition comprising:
a urethane acrylate adduct comprising the reaction product of:
an isocyanate component comprising:
toluene diisocyanate present in an amount of at least 25 parts by weight based on the total weight of said isocyanate component; and
polymeric polyphenylmethane polyisocyanate; and
a stoichiometric excess of a functionalized acrylate component that is reactive with said isocyanate component.

14. A urethane acrylate composition as set forth in claim 13 wherein said toluene diisocyanate is present in said isocyanate component in an amount of from 25 to 80 parts by weight based on the total weight of said isocyanate component.

15. A urethane acrylate composition as set forth in claim 13 wherein said polymeric polyphenylmethane polyisocyanate is present in an amount of at least 10 parts by weight based on the total weight of said isocyanate component.

16. A urethane acrylate composition as set forth in claim 13 wherein said isocyanate component further comprises monomeric diphenylmethane diisocyanate.

17. A urethane acrylate composition as set forth in claim 13 wherein at least one of said toluene diisocyanate and said polymeric polyphenylmethane polyisocyanate are in said isocyanate component as an isocyanate pre-polymer.

18. A urethane acrylate composition as set forth in claim 13 wherein a molar equivalent ratio of said functionalized acrylate component to said isocyanate component is at least 1.1:1.

19. A urethane acrylate composition as set forth in claim 13 wherein said functionalized acrylate component has at least one isocyanate-reactive group selected from the group of hydroxy-functional groups, amine-functional groups, and combinations thereof.

20. A urethane acrylate composition as set forth in claim 19 wherein said functionalized acrylate component has an alkyl chain having from one to twenty carbon atoms.

21. A urethane acrylate composition as set forth in claim 13 further comprising an inhibitor.

22. A urethane acrylate composition as set forth in claim 21 wherein said inhibitor comprises a compound having the formula: 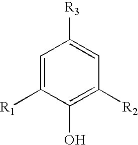
wherein
R₁ and R₂ are each selected from the group of aliphatic groups having from one to twenty carbon atoms, aromatic groups having from six to twenty carbon atoms, and combinations thereof; and
R₃ is selected from the group of hydrogen, hydroxyl groups, alkyl groups, aryl groups, alkaryl groups, amine groups, and combinations thereof.

23. A urethane acrylate composition as set forth in claim 21 wherein said inhibitor comprises a compound having the formula: 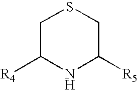
wherein R₄ and R₅ are each selected from the group of aliphatic groups having from one to twenty carbon atoms, aromatic groups having from one to twenty carbon atoms, and combinations thereof.

24. A urethane acrylate composition as set forth in claim 13 further comprising a catalyst.

25. A urethane acrylate composition as set forth in claim 13 further comprising a reactive diluent.

26. A urethane acrylate composition as set forth in claim 13 having a viscosity of less than 7500 centipoise at a temperature of 25° C.

27. A urethane acrylate adduct comprising the reaction product of:
an isocyanate component comprising:
toluene diisocyanate present in an amount of at least 25 parts by weight based on the total weight of said isocyanate component; and
polymeric polyphenylmethane polyisocyanate; and
a stoichiometric excess of a functionalized acrylate component that is reactive with said isocyanate component.

28. A urethane acrylate adduct as set forth in claim 27 wherein said toluene diisocyanate is present in said isocyanate component in an amount of from 25 to 80 parts by weight based on the total weight of said isocyanate component.

29. A urethane acrylate adduct as set forth in claim 27 wherein said polymeric polyphenylmethane polyisocyanate is present in an amount of at least 10 parts by weight based on the total weight of said isocyanate component.

30. A urethane acrylate adduct as set forth in claim 27 wherein said isocyanate component further comprises monomeric diphenylmethane diisocyanate.

31. A urethane acrylate adduct as set forth in claim 27 wherein at least one of said toluene diisocyanate and said polymeric polyphenylmethane polyisocyanate are in said isocyanate component as an isocyanate pre-polymer.

32. A urethane acrylate adduct as set forth in claim 27 wherein a molar equivalent ratio of said functionalized acrylate component to said isocyanate component is at least 1.1:1.

33. A urethane acrylate adduct as set forth in claim 27 wherein said functionalized acrylate component has at least one isocyanate-reactive group selected from the group of hydroxy-functional groups, amine-functional groups, and combinations thereof.

34. A urethane acrylate adduct as set forth in claim 33 wherein said functionalized acrylate component has an alkyl chain having from one to twenty carbon atoms.

35. A urethane acrylate adduct as set forth in claim 27 having a viscosity of less 7500 centipoise at a temperature of 25° C.
